(19) United States
(12) Patent Application Publication
(10) Pub. No.: US 2016/0339853 A1
(43) Pub. Date: Nov. 24, 2016

(54) WIRE HARNESS

(71) Applicant: YAZAKI CORPORATION, Tokyo (JP)

(72) Inventors: Hideaki KIKUCHI, Shizuoka (JP); Tohru YAMAGUCHI, Shizuoka (JP); Masahiro ITO, Shizuoka (JP); Junichi MURAMATSU, Shizuoka (JP); Tatsuya SHIRATORI, Shizuoka (JP)

(21) Appl. No.: 15/159,599

(22) Filed: May 19, 2016

(30) Foreign Application Priority Data
May 21, 2015 (JP) 2015-103369

(51) Int. Cl. B60R 16/02; H01B 7/282; H01B 9/00

(52) U.S. Cl. CPC B60R 16/0215; H01B 9/003; H01B 7/282

(57) ABSTRACT

A wire harness includes a power line that extends from a power-supply control box to supply electrical power to one or more power-requiring devices; a communication line that extends from the power-supply control box to perform communication with one or more communication devices; a plurality of area drivers that are coupled with the power line and the communication line and are coupled to three or more of devices out of the one or more power-requiring devices and the one or more communication devices within each of areas; and individual electrical wires that couple the three or more of devices within the respective areas to the plurality of area drivers.

### CROSS-REFERENCE TO RELATED APPLICATION(S)

The present application claims priority to and incorporates by reference the entire contents of Japanese Patent Application No. 2015-103369 filed in Japan on May 21, 2015.

### BACKGROUND OF THE INVENTION

1. Field of the Invention

The present invention relates to a wire harness.

2. Description of the Related Art

Conventionally, inside a vehicle, a wire harness has been provided for the communication with various devices and for the supply of electrical power thereto (see Japanese Patent Application Laid-open No. 2014-218224).

In recent years, there has been a tendency of an increase in the number of in-vehicle devices, and the number of electrical wires included in wire harnesses has also been on the rise. When the number of electrical wires included in wire harnesses increases, the fuel consumption is deteriorated due to the weight of the electrical wires, and the ease of wiring is also deteriorated as the diameter of the harness gets thicker.

### SUMMARY OF THE INVENTION

An object of the present invention is to provide a wire harness that can improve fuel consumption and facilitate wiring.

In order to achieve the above mentioned object, a wire harness that is electrically coupled to various devices installed on a vehicle according to one aspect of the present invention includes a central unit configured to supply electrical power to one or more power-requiring devices and perform communication with one or more communication devices; a power line configured to extend from the central unit to supply electrical power to the one or more power-requiring devices; a communication line configured to extend from the central unit to perform communication with the one or more communication devices; a plurality of area drivers configured to be provided one on each of a plurality of areas defined in the vehicle, coupled with the power line and the communication line, and coupled to three or more of devices out of the one or more power-requiring devices and the one or more communication devices within each area; and individual electrical wires configured to couple the three or more of devices within the respective areas to the plurality of area drivers.

In the wire harness according to the present invention, because the area drivers that are coupled to the three or more of devices out of the one or more power-requiring devices and the one or more communication devices within the area are included, there is no need to couple the central unit to each of the three or more devices with power lines and communication lines, and the area drivers are to interpose between the central unit and the three or more of devices. Hence, the central unit and each of the area drivers need to couple with, for example, a single power line and a single communication line, and thus the number of electrical wires between the central unit and the area drivers can be reduced. Consequently, the weight and the diameter of the wire harness can be reduced. Furthermore, because the area driver is coupled to the three or more of devices within an area, and functions as a device provided in a form of an integrator of a certain area such as a door, a roof, and others, the area driver can be placed close to the doors, the roof, and others. Thus, the distance between the central unit and each area driver can be elongated, and the region under the area driver, in which the electrical wires increase in numbers, can be made as short as possible. Consequently, the weight of the wire harness can be further reduced. As described above, fuel consumption can be improved and wiring can be facilitated.

A device within an area may have the functions of a power-requiring device and a communication device, such as an imaging unit and a distance measuring unit, receiving electrical power from the central unit and performing communication with the central unit. Because of having both functions of a power-requiring device and a communication device, such a device is equivalent to one power-requiring device and one communication device and corresponds to the concept of two devices in the foregoing.

According to another aspect of the present invention, in the wire harness, it is preferable that the power line and the communication line that couple the central unit to at least one of the plurality of area drivers are placed in a flex portion in which electrical wires are repeatedly flexed.

With this wire harness, because the power line and the communication line coupling the central unit and the area driver are placed in the flex portion, the number of electrical wires used in the flex portion is reduced, there is no need to place many electrical wires of high flex resistance in the flex portion, and it only needs to use electrical wires of superior flex resistance only for the above-described power line and the communication line. Thus, the number of use of flex-resistant electrical wires can be reduced.

According to still another aspect of the present invention, in the wire harness, it is preferable that the power line and the communication line that couple the central unit to at least one of the plurality of area drivers are placed inside a pillar.

With this wire harness, the power line and the communication line coupling the central unit and the area driver are placed inside the pillar. The electrical wires to be wired in a narrow region of the inside of the pillar, the electrical wires to be wired are the power line and the communication line, not many electrical wires as in a conventional manner. Thus, the wire harness that can also make the pillar small can be provided.

According to still another aspect of the present invention, in the wire harness, it is preferable that the central unit and at least one of the plurality of area drivers are coupled through the power line and the communication line which are wired inside a through-hole provided on a specific member to ensure a wiring route.

With this wire harness, the central unit and the area driver are coupled through the power line and the communication line being wired inside a through-hole that is provided on a specific member to ensure a wiring route. As described above, because the power line and the communication line are being wired in the through-hole without many electrical wires being wired as in a conventional manner, the size of the through-hole itself can be reduced. Hence, for example, the deterioration in waterproof and the scaling up of a water-stopping member attached to the through-hole due to a large through-hole can be prevented.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating a configuration of a wire harness according to an embodiment of the present invention;

FIG. 2 is a diagram illustrating one example of a flex portion;

FIG. 3 is a diagram schematically illustrating a wiring example of a power line and a communication line coupling a power-supply control box and a third area driver; and

FIGS. 4A and 4B are diagrams schematically illustrating a wiring example of a power line and a communication line coupling the power-supply control box and a fourth area driver while FIG. 4A illustrates a side view and FIG. 4B illustrates one component inside a vehicle.

### DETAILED DESCRIPTION OF THE PREFERRED EMBODIMENT

The following describes the present invention along an exemplary preferred embodiment. The invention, however, is not limited to the following embodiment, and can be modified as appropriate within the scope of not departing from the purpose of the present invention.

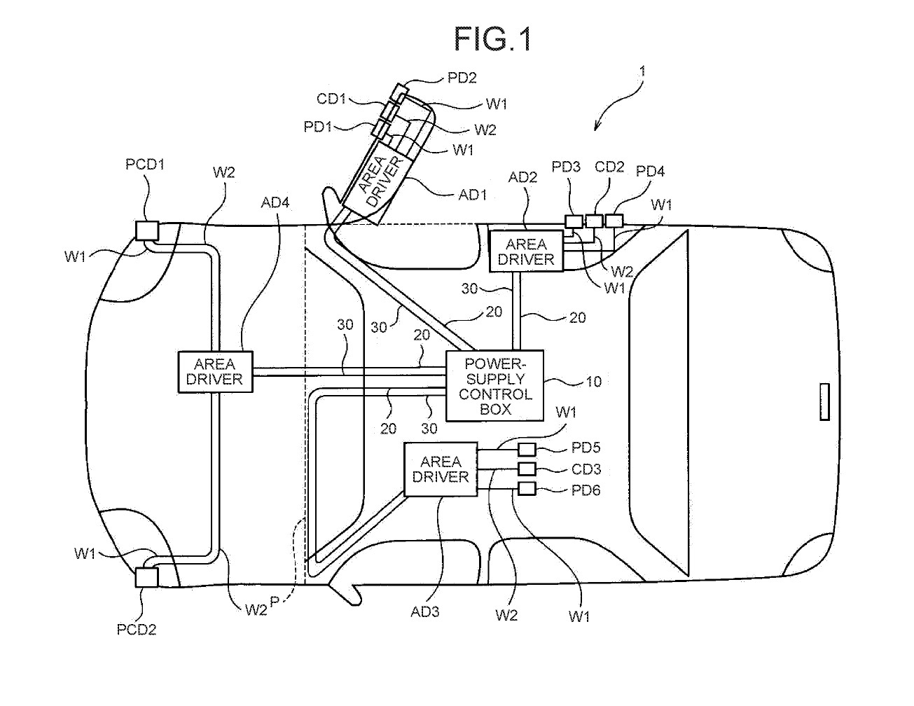

FIG. 1 is a diagram illustrating a configuration of a wire harness according to the embodiment of the present invention. As illustrated in FIG. 1, a wire harness 1 in the embodiment is being wired inside a vehicle, and electrically couples a plurality of devices PD1 to PD6, CD1 to CD3, PCD1, and PCD2. The wire harness 1 is structured with a power-supply control box (a central unit) 10, a plurality of (four, in the embodiment) area drivers AD1 to AD4, a plurality of (four, in the embodiment) power lines 20, a plurality of (four, in the embodiment) communication lines 30, and individual electrical wires W1 and W2.

The power-supply control box 10 supplies, out of the devices PD1 to PD6, CD1 to CD3, PCD1, and PCD2, electrical power to one or more (eight, in the embodiment) power-requiring devices PD1 to PD6, PCD1, and PCD2 and performs communication with one or more (five, in the embodiment) communication devices CD1 to CD3, PCD1, and PCD2. The power-supply control box 10 is coupled to a battery not depicted and supplies the electrical power from the battery to the power-requiring devices PD1 to PD6, PCD1, and PCD2. Furthermore, the power-supply control box 10 is coupled to an ECU not depicted (for example, an automated cruise ECU that performs determination of automated cruise) and supplies signals obtained from the communication devices CD1 to CD3, PCD1, and PCD2 to the ECU.

As for the communication devices CD1 to CD3, PCD1, and PCD2, examples include an information acquisition unit such as a sensor and others. As for the power-requiring devices PD1 to PD6, PCD1, and PCD2, examples include a motor and others. As with the devices PCD1 and PCD2, the devices that receive electrical power and transmit, to the power-supply control box 10, information acquired by operation using the supplied electrical power, that is, being a power-requiring device and being a communication device (hereinafter, also referred to as power-requiring communication device), are also present. Such devices correspond to a camera (an imaging unit) that outputs an imaging signal acquired by imaging the surround of the vehicle, a sonar (a distance measuring unit) that detects the presence of a surrounding object and outputs a signal corresponding to the distance to the object, and others.

The power lines 20 are the electrical wires extending from the power-supply control box 10 and being wired to supply electrical power to the power-requiring devices PD1 to PD6, PCD1, and PCD2. The communication lines 30 are the electrical wires extending from the power-supply control box 10 and being wired to perform communication with the communication devices CD1 to CD3, PCD1, and PCD2. Because the purpose of the communication lines 30 is not to supply electrical power, electrical wires of a diameter smaller than that of the power lines 20 tend to be used therefor.

The respective area drivers AD1 to AD4 are provided one on each of a plurality of areas defined in the vehicle, are coupled with the power line 20 and the communication line 30, and are coupled to three or more of the devices PD1 to PD6, CD1 to CD3, PCD1, and PCD2, out of one or more of the power-requiring devices PD1 to PD6, PCD1, and PCD2 and one or more of the communication devices CD1 to CD3, PCD1, and PCD2, within each area.

For example, the first area driver AD1 is coupled to two power-requiring devices PD1 and PD2 and one communication device CD1 in a right front door area as one of the areas. The first area driver AD1 is coupled to the two power-requiring devices PD1 and PD2 with individual power lines (individual electrical wires) W1 and is coupled to the one communication device CD1 with an individual communication line (an individual electrical wire) W2.

Consequently, the electrical power from the power-supply control box 10 is supplied to the first area driver AD1 through the power line 20, is branched off in the first area driver AD1, and is supplied to the two power-requiring devices PD1 and PD2 from the respective individual power lines W1. The signal from the one communication device CD1 reaches the first area driver AD1 through the individual communication line W2, and is transmitted to the power-supply control box 10 from the first area driver AD1 through the communication line 30.

In the same manner, the second area driver AD2 is coupled to, through individual power lines W1 and an individual communication line W2, two power-requiring devices PD3 and PD4 and one communication device CD2 in a right rear door area as one of the areas. The electrical power from the power-supply control box 10 is supplied to the two power-requiring devices PD3 and PD4 through the power line 20, the second area driver AD2, and the individual power lines W1. The signal from the one communication device CD2 is transmitted to the power-supply control box 10 through the individual communication line W2, the second area driver AD2, and the communication line 30.

The third area driver AD3 is coupled to, through individual power lines W1 and an individual communication line W2, two power-requiring devices PD5 and PD6 and one communication device CD3 in a roof area as one of the areas. The electrical power from the power-supply control box 10 is supplied to the two power-requiring devices PD5 and PD6 through the power line 20, the third area driver AD3, and the individual power lines W1. The signal from the one communication device CD3 is transmitted to the power-supply control box 10 through the individual communication line W2, the third area driver AD3, and the communication line 30.

The fourth area driver AD4 is coupled to, through individual power lines W1 and individual communication lines W2, two power-requiring communication devices PCD1 and PCD2 in an engine-room side area as one of the areas. The electrical power from the power-supply control box 10 is supplied to the two power-requiring communication devices PCD1 and PCD2 through the power line 20, the fourth area driver AD4, and the individual power lines W1. Thus, the two power-requiring communication devices PCD1 and PCD2 are driven and acquire information and others, and transmit signals obtained by the information acquisition to the power-supply control box 10 through the individual communication lines W2, the fourth area driver AD4, and the communication line 30.

As for the power-requiring communication devices PCD1 and PCD2, because of having both functions of a power-requiring device and a communication device, they are each equivalent to one power-requiring device and one communication device and correspond to the concept of two devices in the foregoing. Consequently, it can be said that the fourth area driver AD4 is coupled to four devices of PCD1 and PCD2 within the area.

Because of such a wiring structure of the wire harness 1, there is no need to couple the power-supply control box 10 to each of the devices PD1 to PD6, CD1 to CD3, PCD1, and PCD2 with the power lines 20 and the communication lines 30. That is, the area drivers AD1 to AD4 interpose between the power-supply control box 10 and three or more of the devices PD1 to PD6, CD1 to CD3, PCD1, and PCD2. Hence, the power-supply control box 10 and each of the respective area drivers AD1 to AD4 need to couple with, for example, a single power line 20 and a single communication line 30, and thus the number of electrical wires that are between the power-supply control box 10 and the area drivers AD1 to AD4 is reduced.

Moreover, because the area drivers AD1 to AD4 are coupled to three or more of the devices PD1 to PD6, CD1 to CD3, PCD1, and PCD2, the area drivers AD1 to AD4 function as a device provided in a form of an integrator of a certain area such as a door, a roof, and others.

Consequently, because the area drivers AD1 to AD4 can be placed close to the doors, the roof, and others, the distance between the power-supply control box 10 and the area drivers AD1 to AD4 can be elongated, and the regions on the device side under the area drivers AD1 to AD4, in which the electrical wires increase in numbers, can be made as short as possible.

The power lines 20 and the communication lines 30 that couple the power-supply control box 10 and the first and second area drivers AD1 and AD2 are placed in a flex portion in which the power line 20 and the communication line 30 are repeatedly flexed. In more detail, the first and second area drivers AD1 and AD2 are provided in the door areas. Due to the vehicle doors being opened and closed a plurality of times, the electrical wires coupling the vehicle body side and the doors are subjected to repetition of flexing according to the opening and closing. The electrical wires that are subjected to such repetition of flexing are the power lines 20 and the communication lines 30 coupled to the first and second area drivers AD1 and AD2.

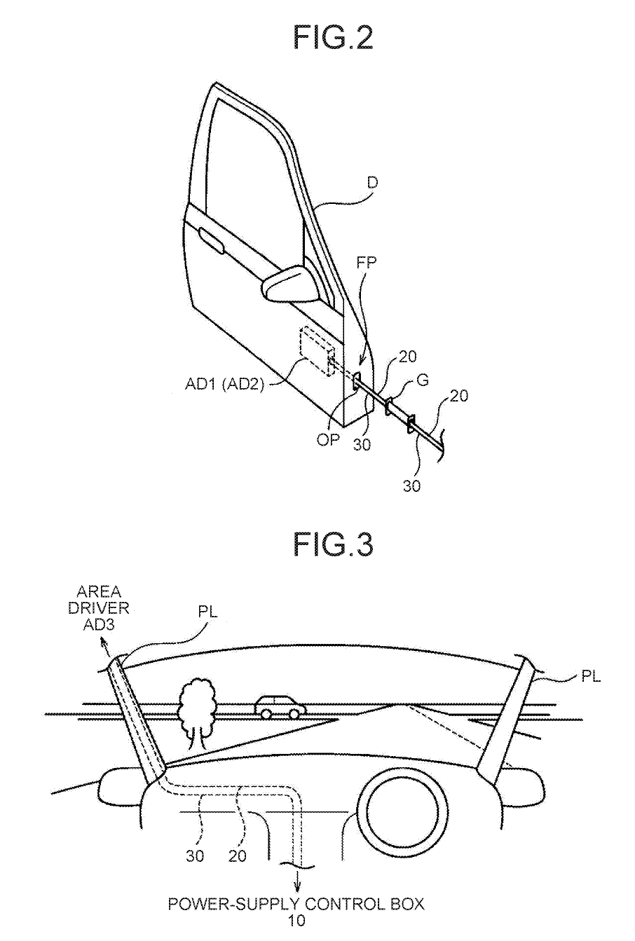

FIG. 2 is a diagram illustrating one example of the flex portion. As illustrated in FIG. 2, a certain opening OP is formed on a door D, and through the opening OP, the power line 20 and the communication line 30 are being wired. Consequently, the first and second area drivers AD1 and AD2 are not built into the vehicle body side, but the door D side. On the opening OP, in terms of protecting the power line 20 and the communication line 30, and in terms of achieving waterproofing, a grommet G is provided, and the installed location of the grommet G and others represents a flex portion FP.

In this way, the number of electrical wires used in the flex portion FP is reduced (that is, the power line 20 and the communication line 30 are provided in the flex portion FP, and the individual power lines W1 and the individual communication lines W2 are not provided), there is no need to place many electrical wires of high flex resistance in the flex portion FP, and it only needs to use electrical wires of superior flex resistance for the above-described power line 20 and the communication line 30. Hence, the number of use of flex-resistant electrical wires can be reduced.

The flex portion FP is not limited to the installed location of the grommet G and others on the door, and it may be other locations as long as the locations are subjected to repetition of flexing. For example, because the electrical wires also placed inside a steering wheel are subjected to repetition of flexing according to the steering operation, a location subjected to such flexing corresponds to the flex portion FP.

In particular, in this case, because the first and second area drivers AD1 and AD2 are placed inside the door and inside the steering wheel, the first and second area drivers AD1 and AD2 are brought further close to the devices PD1 to PD4, CD1, and CD2, and thus the lengths of the regions including many electrical wires (that is, the lengths of the individual power lines W1 and the individual communication lines W2) are made even shorter.

Furthermore, the power lines 20 and the communication lines 30 that couple the power-supply control box 10 and the third area driver AD3 are placed inside a pillar.

FIG. 3 is a diagram schematically illustrating a wiring example of the power line 20 and the communication line 30 coupling the power-supply control box 10 and the third area driver AD3. As illustrated in FIG. 3, as a structure to support the roof of the vehicle, a pillar (in FIG. 3, an A-pillar PL is depicted) is known. The inside of the pillar is hollow, and the power line 20 and the communication line 30 coupling the power-supply control box 10 and the third area driver AD3 are being wired inside the A-pillar PL, namely, a pillar hollow portion. Consequently, the third area driver AD3 is installed on the roof side.

In general, the pillar interrupts the field of view of a driver, and thus it is preferable to be as thin as possible under a condition of being capable of supporting the roof. For this reason, by wiring inside the A-pillar PL the power line 20 and the communication line 30 coupling the power-supply control box 10 and the third area driver AD3, the electrical wires being wired in a narrow region of the inside of the A-pillar PL are the power line 20 and the communication line 30, not many electrical wires as in a conventional manner. Consequently, this makes the A-pillar PL also smaller, contributing to expand the area of the field of view of the driver.

Moreover, in this case also, because the third area driver AD3 is placed in the roof, the third area driver AD3 is brought close to the devices PD5, PD6, and CD3, and thus the lengths of the regions including many electrical wires are made even shorter.

In addition, the power-supply control box 10 and the fourth area driver AD4 are coupled through the power line 20 and the communication line 30 being wired inside a through-hole that is provided on a specific member to ensure a wiring route.

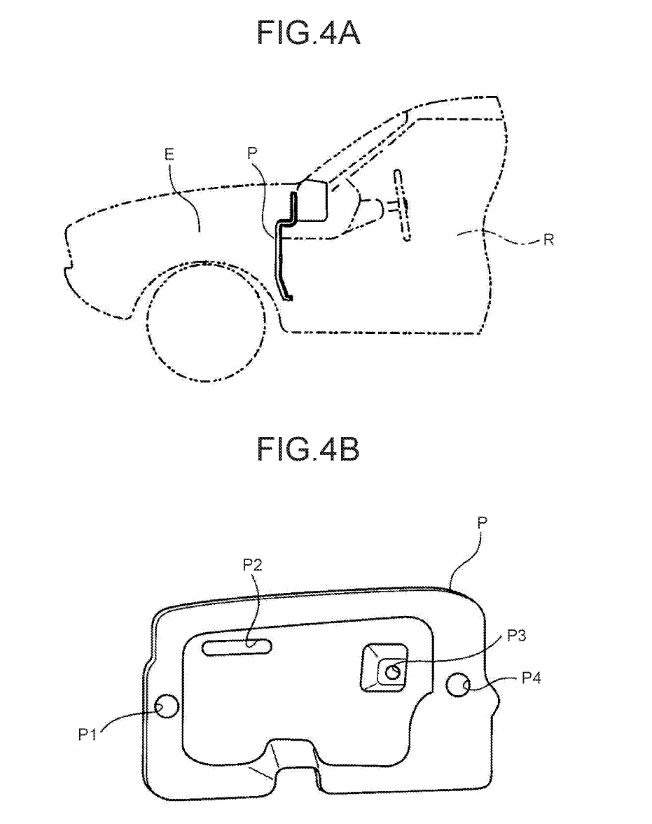

FIGS. 4A and 4B are diagrams schematically illustrating a wiring example of the power line 20 and the communication line 30 coupling the power-supply control box 10 and the fourth area driver AD4 while FIG. 4A illustrates a side view and FIG. 4B illustrates one component in the vehicle.

As illustrated in FIG. 4A, the vehicle has an engine room E and a vehicle compartment R, and includes a metal panel (a specific member) P made of metal interposed between the engine room E and the vehicle compartment R to separate both spaces. As illustrated in FIG. 4B, on the metal panel P, a plurality of through-holes P1 to P4 are provided. Each of the through-holes P1 to P4 is provided with a water-stopping member such as a grommet. Thus, the rainwater and others penetrating into the engine room E is prevented from penetrating into the vehicle compartment R through the through-holes P1 to P4. Moreover, because the metal panel P is made of metal, it has a shielding effect against noise and others.

The power-supply control box 10 and the fourth area driver AD4 are coupled through the power line 20 and the communication line 30 being wired through any of the through-holes P1 to P4 provided on the metal panel P to ensure the wiring route. Thus, in any of the through-holes P1 to P4, because the power line 20 and the communication line 30 are being wired without many electrical wires being wired as in a conventional manner, the sizes of the through-holes P1 to P4 themselves can be reduced. In terms of the downsizing of the water-stopping members, and the penetration of rainwater and others, it is preferable that the through-holes P1 to P4 be small holes, and in terms of the shielding effect also, it is preferable that the through-holes P1 to P4 be small holes. Because the power-supply control box 10 and the fourth area driver AD4 are coupled through the through-holes P1 to P4 with the power line 20 and the communication line 30, for example, the deterioration in waterproof and the scaling up of the water-stopping members attached to the through-holes P1 to P4 due to the through-holes P1 to P4 being large can be prevented. Moreover, the degradation of shielding effect can be suppressed.

In FIGS. 4A and 4B, as the through-holes provided on a specific member to ensure a wiring route, the through-holes P1 to P4 provided on the metal panel P are illustrated. However, the through-holes are not limited to these, and the opening OP also, which is provided on the door D illustrated in FIG. 2, corresponds to the concept of the through-hole provided on a specific member to ensure a wiring route.

As in the foregoing, in the wire harness 1 in the embodiment, because the area drivers AD1 to AD4 that are coupled to three or more of the devices PD1 to PD6, CD1 to CD3, PCD1, and PCD2, out of one or more of the power-requiring devices PD1 to PD6, PCD1, and PCD2 and one or more of the communication devices CD1 to CD3, PCD1, and PCD2, within each area are included, there is no need to couple the power-supply control box 10 and the respective devices PD1 to PD6, CD1 to CD3, PCD1, and PCD2 with the power lines 20 and the communication lines 30, and the area drivers AD1 to AD4 interpose between the power-supply control box 10 and the three or more of the devices PD1 to PD6, CD1 to CD3, PCD1, and PCD2. Hence, the power-supply control box 10 and each of the respective area drivers AD1 to AD4 need to couple with, for example, a single power line 20 and a single communication line 30, and thus the number of electrical wires that are between the power-supply control box 10 and the area drivers AD1 to AD4 is reduced. Thus, the weight and the diameter of the wire harness 1 can be reduced. Furthermore, because the area drivers AD1 to AD4 are coupled to the three or more of the devices PD1 to PD6, CD1 to CD3, PCD1, and PCD2 and are to function as a device provided in a form of an integrator of a certain area such as a door, a roof, and others, the area drivers AD1 to AD4 can be placed close to the doors, the roof, and others. Thus, the distance between the power-supply control box 10 and the area drivers AD1 to AD4 can be elongated, and the regions under the area drivers AD1 to AD4 in which the electrical wires increase in numbers can be made as short as possible. Consequently, the weight of the wire harness 1 can be further reduced. As described above, fuel consumption can be improved and wiring can be facilitated.

The power lines 20 and the communication lines 30 that couple the power-supply control box 10 and the first and second area drivers AD1 and AD2 are placed in the flex portions FP in which electrical wires are repeatedly flexed. Consequently, the number of electrical wires used in the flex portion FP is reduced, there is no need to place many electrical wires of high flex resistance in the flex portion FP, and it only needs to use electrical wires of superior flex resistance for the above-described power line 20 and the communication line 30. Thus, the number of use of flex-resistant electrical wires can be reduced.

Furthermore, the power line 20 and the communication line 30 coupling the power-supply control box 10 and the third area driver AD3 are placed inside the A-pillar PL, and the electrical wires to be wired in a narrow region of the inside of the A-pillar PL are the power line 20 and the communication line 30, not many electrical wires as in a conventional manner. Thus, the wire harness 1 that enables use of a smaller A-pillar PL can be provided.

The power-supply control box 10 and the fourth area driver AD4 are coupled through the power line 20 and the communication line 30 being wired in any of the through-holes P1 to P4 provided on the metal panel P to ensure the wiring route. As described above, in the through-holes P1 to P4, because the power line 20 and the communication line 30 are being wired without many electrical wires being wired as in a conventional manner, the sizes of the through-holes P1 to P4 themselves can be reduced. Hence, for example, the deterioration in waterproof and the scaling up of the water-stopping members attached to the through-holes P1 to P4 due to the through-holes P1 to P4 being large can be prevented. The same applies to the first and second area drivers AD1 and AD2.

As in the foregoing, the present invention has been described based on the embodiment. The invention, however, is not limited to this and, without departing from the scope of the purpose of the present invention, modifications may be added and other technologies may be combined to the extent possible as appropriate.

For example, in the above-described embodiment, to each of the area drivers AD1 to AD4, three or four devices (the power-requiring communication devices PCD1 and PCD2 are converted to two devices each) are coupled, but the present invention is not limited to the embodiment and five or more devices may be coupled. Moreover, the installed locations of the area drivers AD1 to AD4 are not limited to the doors, the roof, and the engine room E, and may be installed at other locations such as a rear portion of the vehicle.

As long as the area drivers AD1 to AD4 are coupled to three or more of the devices PD1 to PD6, CD1 to CD3, PCD1, and PCD2 such that at least three electrical wires W1 and W2 are present, the type of connection object is not a matter. Consequently, to the area drivers AD1 to AD4, one of the power-requiring communication devices PCD1 and PCD2 and one of the communication devices CD1 to CD3 may be coupled, for example.

Although only one power-supply control box 10 is illustrated in the above-described embodiment, the present invention is not limited to the embodiment and two or more of the power-supply control boxes 10 may be included. Moreover, the above-described embodiment includes four area drivers AD1 to AD4. However, the present invention is not limited to the embodiment and the number of the area drivers AD1 to AD4 may be two, three, or five or more.

In the example illustrated in FIG. 2, it is configured such that the flex portion FP interposes between the power-supply control box 10 and the first and second area drivers AD1 and AD2. However, the present invention is not limited to the embodiment and it may be configured such that the flex portion FP interposes between the first and second area drivers AD1 and AD2 and each of the three or more of the devices PD1 to PD6, CD1 to CD3, PCD1, and PCD2. Consequently, although the number of use of flex-resistant electrical wires increases, it only needs to use the flex-resistant electrical wires in a short section that is between the first and second area drivers AD1 and AD2 and each of the three or more of the devices PD1 to PD6, CD1 to CD3, PCD1, and PCD2. Thus, the electrical wires for a long section between the power-supply control box 10 and each of the first and second area drivers AD1 and AD2 no longer need to be of superior flex-resistant electrical wires, and the wire harness 1 that is excellent in cost can be provided.

According to the present invention, a wire harness that can improve fuel consumption and facilitate wiring can be provided.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A wire harness that is electrically coupled to various devices installed on a vehicle, the wire harness comprising:
a central unit configured to supply electrical power to one or more power-requiring devices and perform communication with one or more communication devices;
a power line configured to extend from the central unit to supply electrical power to the one or more power-requiring devices;
a communication line configured to extend from the central unit to perform communication with the one or more communication devices;
a plurality of area drivers configured to be provided one on each of a plurality of areas defined in the vehicle, coupled with the power line and the communication line, and coupled to three or more of devices out of the one or more power-requiring devices and the one or more communication devices within each area; and
individual electrical wires configured to couple the three or more of devices within the respective areas to the plurality of area drivers.

2. The wire harness according to claim 1, wherein
the power line and the communication line that couple the central unit to at least one of the plurality of area drivers are placed in a flex portion in which electrical wires are repeatedly flexed.

3. The wire harness according to claim 1, wherein
the power line and the communication line that couple the central unit to at least one of the plurality of area drivers are placed inside a pillar.

4. The wire harness according to claim 1, wherein
the central unit and at least one of the plurality of area drivers are coupled through the power line and the communication line which are wired inside a through-hole provided on a specific member to ensure a wiring route.
